(19) United States
(12) Patent Application Publication
(10) Pub. No.: US 2006/0266172 A1
(43) Pub. Date: Nov. 30, 2006

(54) Tool head, adjuster ring and cutting machine in particular a scalping machine

(75) Inventors: Heinz-Willi Greuel, Eschweiler (DE); Udo Gehrer, Wurselen (DE); Jorg Lindbuchl, Monschau/Konzen (DE); Ludwig Jung, Simmerath/Lammersdorf (DE); Alfred Bartz, Walhorn/Lontzen (BE)

Correspondence Address: WILLIAM COLLARD;COLLARD & ROE, P.C., 1077 NORTHERN BOULEVARD, ROSLYN, NY, 11576, US

(73) Assignee: SCHUMAG AG, AACHEN (DE)

(21) Appl. No.: 10/531,903

(22) PCT Filed: Oct. 20, 2003
(86) PCT No.: PCT/DE03/03516

§ 371 Date: Nov. 2, 2005

(30) Foreign Application Priority Data
Oct. 18, 2002 (DE) 102 48 861.4
Oct. 18, 2002 (DE) 102 48 862.2
Oct. 18, 2002 (DE) 102 48 863.0
Feb. 18, 2003 (DE) 103 06 831.7
Feb. 18, 2003 (DE) 103 06 832.5
Feb. 18, 2003 (DE) 103 06 833.3

(51) Int. Cl. B23B 17/00

(52) U.S. Cl. 82/149

(57) ABSTRACT

According to the invention, the wear in the region of the tool head (201) of a tool machine in particular a scalping machine for machining long workpieces with a round cross-section may be reduced, whereby a tool head (201) with a tool holder (204) is adjustable essentially radially to the rotation axis (206) and an adjuster device (202) essentially adjustable axially to the rotation axis (206), in which the tool holder (204) and the adjuster device each have planar slide surfaces (208, 220) which correspond to each other.

The invention relates to a tool head having tool holders that are adjustable essentially radially to an axis of rotation, and an adjusting device that is adjustable essentially axially to the axis of rotation, in which device the tool holders and the adjusting device correspond with one another by way of slide surfaces, in each instance. Furthermore, the invention relates to an adjuster ring for setting a tool holder relative to an axis of rotation, whereby the adjuster ring has a conically configured inside for forming a slide bearing half liner. Furthermore, the invention relates to a cutting machine, particularly a peeling machine, for machining long work pieces having a round cross section, particularly cylindrical and also conical work pieces.

Known peeling machines have a peeling head that rotates about an axis of rotation, i.e. about a machining axis, which head has an adjusting device for tool holders that rotate with the peeling head. By means of the adjusting device, these tool holders, with the tools disposed on them, are adjusted relative to a work piece, in such a manner that the tools remove a scale layer from a hot-rolled material, for example, so that after machining of the round material, a metallically shiny round material is present as the result.

Such a peeling machine is described, for example, in DE 101 29 207 A1, in which an adjusting device that can be displaced relative to a hollow shaft is disposed in the region of a peeling head. Depending on the displacement of the adjusting device, the tool holders, i.e. tools that are disposed on them, are moved radially relative to a machining axis. In this way, the tools can be individually adjusted to a diameter of a base material to be machined. At the contact surfaces between the tool holders and the adjusting device, in particular, enormous forces and therefore very high surface pressures are present, which result in great wear both on the adjusting device and on the tool holders, for example.

However, since the replacement of such an adjusting device can be achieved only with significant assembly effort and at significant costs, this is a significant disadvantage of peeling heads up to now. The same also applies, of course, with regard to the wear of the tool holders, since relatively complicated assembly must be performed to replace such tool holders. It often occurs, in this connection, that complete disassembly of the lathe tool adjustment must be performed in the region of the peeling head, in order to replace the worn components. Despite these obvious disadvantages, no solutions to eliminate these disadvantages have been found until now.

Furthermore, a machine for peeling pipes and rods is known from DE 195 03 772 Al. Here, peeling takes place by means of several peeling tools that rotate about a piece to be peeled, which tools are disposed on rod-shaped tool carriers, in each instance. The tool carriers are mounted to be displaceable radially, relative to a longitudinal axis of the piece to be peeled, and supported themselves against the inside of a conical bushing, among other things. In this way, forces that act on the peeling tools, particularly forces that act on the peeling tools essentially radially with regard to the longitudinal axis of the piece to be peeled, are passed to the conical bushing by way of the tool carriers, and from there on to a machine frame. But here again, replacement of the components that are subject to great wear, such as the tool carrier and the conical bushing, can only be achieved with significant assembly effort.

It is therefore the task of the present invention to reduce the risk of wear in the region of a peeling head, in order to avoid complicated assembly work for as long as possible.

The task of the invention is accomplished by a tool head having tool holders that are adjustable essentially radially to an axis of rotation, and an adjusting device that is adjustable essentially axially to the axis of rotation, in which device the tool holders and the adjusting device correspond with one another by way of slide surfaces, in each instance, and the slide surfaces are essentially planar. In contrast to slide surfaces of known adjusting devices, which have been configured conically until now, and tool holders that correspond with them, the adjusting device according to the invention and the tool holders according to the invention have essentially planar slide surfaces, by way of which they correspond with one another and by way of which machining forces that act radially to the axis of rotation, in particular, are passed from the tool holders into the adjusting device.

In a complete break with the state of the art, the present invention therefore does without a cone for the adjusting device in those regions in which the significant adjustment forces occur. Instead, plane surfaces are used in these regions, so that the contact surfaces are essentially independent of the adjustment.

In this way, the risk that only a line-type contact will occur between the slide surfaces, and that therefore, only a small region of the corresponding slide surfaces will absorb and transfer forces, thereby understandably exposing this small region to enormous stresses, is reduced, according to the invention. Because of the essentially planar slide surface, a particularly good distribution of force is achieved, so that surface pressures that occur in the region of the planar slide surfaces can generally be completely absorbed by the entire slide surface.

This results in a significantly increased lifetime of the tool head according to the invention as compared with conventional tool heads.

In the sense of the invention, the term “planar” or “planar slide surface” is understood essentially to mean surfaces that tend to represent a slide surface and are essentially not curved, so that the risk that two planar slide surfaces that correspond with one another will touch one another only in linear manner is reduced. The term planar slide surface particularly refers to flat surfaces, within the scope of normal measurement accuracy, which can have contact with one another over as large an area as possible.

It is possible to prevent wear in particularly inexpensive manner by means of planar slide surfaces. On the other hand, a curved surface that has a constant radius of curvature relative to the axis of rotation can also bring about these advantages, since with such an arrangement, as well, the radius of curvature of the slide surface does not change over the adjustment path, as this would be the case for conical surfaces. The fundamental idea of the invention is therefore to provide a slide surface whose radius of curvature does not change, with regard to the adjustment direction, along the displacement path of the tool holder, whereby a planar slide surface can also be viewed as being a slide surface having an infinite radius of curvature.

The adjusting devices and the tool holders of the tool head according to the invention have a particularly great life expectancy if the slide surfaces are additionally hardened.

In this connection, in particular, an embodiment variant provides that at least one slide surface has an inlay that is preferably produced from a wear-resistant material. If necessary, such an inlay can be replaced quickly and inexpensively. It is true that over and above this, individual planar regions of the adjusting device, which is configured predominantly conically, as mentioned, can be hardened. But this is expensive, so that it is significantly more inexpensive and therefore also makes greater economic sense to make available wear-resistant planar slide surfaces with the inlays.

Furthermore, it is advantageous if the inlay is a small hard metal plate. In this way, the production costs of the adjusting device of the tool holders can be further reduced, since the other components do not also have to be subjected to a surface hardening process. This also further reduces the production costs. By means of the use of a small hard metal plate to implement a planar slide surface, it is possible, in advantageous manner, to use a standardized part for forming a planar slide surface, which part can be mass-produced, in particularly inexpensive manner.

By means of using an inlay of a wear-resistant material, the good damping properties of the softer component (adjusting device and tool holder) are maintained, for one thing, and for another, a wear-resistant component surface (inlay) is created. Therefore the adjusting device and the tool holders are protected against premature wear particularly well and furthermore the adjusting device and the tool holders can continue to damp mechanical jolts, without the risk of being damaged prematurely because of this.

It is particularly advantageous if the inlay is fixed in place on the adjusting device and/or on the tool holders in replaceable manner. It is understood that such an inlay can be disposed on the adjusting device and on the tool holders, respectively, in may different ways. For example, the inlays can be glued on. It is also advantageous if the inlays are attached to the adjusting device and/or to the tool holders by means of a screw connection, for example with four cylinder-head screws, in releasable and replaceable manner.

Particularly with regard to screwed-on inlays, there is the possibility of replacing worn inlays with new inlays without having to completely replace the adjusting device or the tool holders in this connection. In this way, disassembly of the tool head can be prevented to the greatest possible extent.

A particular embodiment variant provides that the adjusting device furthermore has a conical bushing. A conical bushing is well suited to be displaced axially along a shaft, and furthermore to displace other components radially with regard to the shaft by means of its conical modules. In this regard, the advantages of a conical bushing can be utilized for other components, while for the remainder, wear at the surfaces subject to great stress is reduced by means of the slide surfaces according to the invention.

Preferably, the conical bushing is an adjuster ring. In this way, an adjusting device that can furthermore be displaceable to a hollow shaft is created, with a particularly simple construction.

In order for a slide surface of an adjusting device and a slide surface of a corresponding tool holder to be in active contact with one another over as large a surface as possible, it is advantageous if a planar slide surface of the adjusting device is disposed essentially parallel to a corresponding slide surface of a tool holder, preferably a planar slide surface of a tool holder. By means of a good parallelity between the two slide surfaces, there is a particularly good active contact and a good distribution of force, i.e. a correspondingly low surface pressure, over as large a region of the slide surfaces as possible.

The task of the invention is also accomplished by an adjuster ring for adjusting a tool holder relative to an axis of rotation, whereby the adjuster ring has a conically configured inside for forming a slide bearing half liner surface, and the conical slide bearing half liner surface has at least one essentially planar slide bearing.

Accordingly, it is particularly advantageous if the inside of the adjuster ring is configured to be planar, at least in partial regions, particularly in the region of the slide surfaces. In this way, a transfer of force between the adjuster ring and a tool holder can take place over a large area, thereby significantly reducing the stress on the components in these regions.

By means of the adjuster ring, the slide surface having rotation symmetry can be utilized, for one thing, making it possible to displace the adjuster ring further with regard to a hollow shaft, as well, with a particularly simple construction. On the other hand, the adjuster ring according to the invention is significantly more resistant to wear in the regions that are subject to particularly great stress, in which the adjuster ring enters into active contact with the tool holder on its slide surfaces according to the invention. In this way, the lifetime of the adjuster ring is significantly increased.

It is particularly advantageous if the planar slide bearing region can be attached to the adjuster ring in releasable and replaceable manner. This makes it possible not to have to replace the complete adjuster ring if a slide bearing region is worn, and to replace only a part in the region of the slide bearing surfaces. This reduces the maintenance costs, among other things, since the adjuster ring as such can be used significantly longer.

A wear-resistant slide bearing half shell surface can be implemented with a particularly simple construction if the slide bearing region has an inlay that has harder material properties than the wear ring. Preferably, this inlay is a standardized part that is mass-produced. It is understood that the inlay is significantly easier to harden than this would be possible with regard to the inside of a slide bearing half shell surface of an adjuster ring.

Furthermore, the task of the invention is accomplished by a cutting machine tool, particularly a peeling machine, for machining linear work pieces, which has a tool head and/or an adjuster ring for adjusting a tool holder, having at least one of the characteristics described above.

Cumulatively or alternatively, an advancing apparatus with insertion rollers for accelerating work pieces, particularly rods, pipes, round bars, wires, cables, or the like, is proposed, particularly for a peeling machine, in which the insertion rollers are driven by an insertion roller shaft, in each instance, whereby at least one insertion roller shaft is mounted eccentrically in a shaft accommodation. In this connection, the insertion roller shaft, in other words the driving shaft per insertion roller, is advantageously mounted in the shaft accommodation in such a manner that the insertion roller shaft is displaced as the shaft accommodation rotates about one of its longitudinal axes. In this way, an adjustment mechanism of an insertion roller shaft is created in structurally particularly simple manner, which mechanism makes it possible to displace the insertion roller shaft from a first position into another position with simple means. Furthermore, the insertion roller shaft is mounted in such a shaft accommodation in particularly robust manner, and therefore is not susceptible to breakdown. Because of the improved guidance that is achieved thereby, particularly of a work piece to be peeled, significantly lower machining forces occur in the region of the peeling head, thereby additionally reducing the wear in the region of the peeling head.

Such advancing apparatuses or insertion rollers configured in such a manner, particularly for accelerating work pieces, such as rods, pipes, round bars, wires, cables, or the like, along a machining axis of a transport segment, in which the insertion rollers are driven by means of an insertion roller shaft, in each instance, are therefore advantageous even independent of the other characteristics of the present invention.

Advancing apparatuses as such are already known from the state of the art and are preferably used to accelerate and transport work pieces in connection with charging work piece machining systems, which subsequently continuously machine the work piece, such as a rod material. Such advancing apparatuses are particularly also used in connection with peeling machines, whereby the insertion rollers serve to accelerate the work piece and to transport the work piece further, to or into the peeling machine. In this connection, the insertion rollers, particularly in the case of smaller work piece diameters, are often offset by an angle relative to a machining axis of the work piece. By means of the slanted positioning of the insertion rollers that is achieved as a result, the work piece is put into rotation, thereby generally improving the peeling result on the work piece. In addition, the work piece rolls about its axis of rotation even after the peeling process, and in an individual case, this is advantageous for the further machining process. In contrast, setting the roller straight when peeling work pieces having larger diameters, as already known from the state of the art, minimizes the wear of the insertion rollers, among other things. It is also known from the state of the art that a peeling machine machines not only pieces having one and the same diameters, but also different work pieces having different diameters. Therefore the insertion rollers of a peeling machine, i.e. of an advancing apparatus, are often individually adjusted to the diameter of the work piece to be machined, in each instance, by means of an adjustment mechanism. However, these known adjustment mechanisms have the disadvantage that they are very susceptible to contamination, so that inaccuracies often occur when setting the insertion rollers, thereby increasing the risk that a production result that is no longer acceptable is achieved because of the degree of contamination. Furthermore, there is the risk that the known adjustment mechanisms cake up and therefore cannot be adjusted precisely, or can only be adjusted with great effort. In the case of the known adjustment mechanisms, critical production parameters occur, again and again, and furthermore cleaning known adjustment mechanisms and putting them back into operation is very complicated, in most cases. These disadvantages can be eliminated by means of the eccentric insertion roller shaft.

In order to make it possible for the insertion roller shaft to be displaced by the shaft accommodation in simple manner, it is advantageous if the shaft accommodation is mounted to rotate about a shaft accommodation axis and is preferably essentially symmetrical with regard to rotation. Such a method of mounting is particularly non-susceptible to contamination, so that such an adjustment mechanism is particularly easy to maintain. Furthermore, this adjustment possibility is particularly inexpensive to produce. A particularly advantageous insertion roller shaft bearing is achieved by means of such a shaft accommodation.

A preferred embodiment variant provides that the shaft accommodation is a bearing bushing and that the bearing bushing is disposed on a holding device to rotate about one of its longitudinal axes, preferably about its center longitudinal axis. In this way, an adjustment mechanism that is particularly robust in construction, for one thing, and particularly compact in construction, for another, is obtained, in order to adjust the insertion rollers individually to the work piece to be machined, in each instance.

Cumulatively or alternatively, it has proven to be advantageous that a bearing body that displaces itself, having a bearing for the insertion roller shaft, such as the shaft accommodation discussed here, is preferably guided on a holding device, for displacing the insertion roller shaft, in such a manner that the bearing of the insertion roller shaft performs a movement having a rotational component about a component axis, which lies in a plane that is disposed parallel to the work piece and is penetrated by the main contact pressure direction in which the insertion roller, in each instance, acts on the work piece. In this regard, the bearing turns the insertion roller shaft at least about one axis, which is disposed at a slant relative to the main contact pressure direction, i.e. intersects an axis that runs parallel to the main contact pressure direction.

By means of this deviation from the main contact pressure direction, the contact pressure forces for the work piece, on the one hand, and the holding forces for the bearing, on the other hand, are oriented separately from one another, and thus significantly less caking can occur, among other things.

Preferably, the axis of rotation of the insertion roller shaft is disposed, relative to the axis of rotation of the shaft accommodation, in such a manner that during a rotation of the shaft accommodation, the axis of rotation of the insertion roller shaft describes a cone in space.

It is advantageous in this connection if the cone has a point that is essentially located in an intersection of the axis of rotation of the insertion roller shaft and a perpendicular of the machining plane, preferably essentially in an intersection of the axis of rotation of the insertion roller shaft and the machining plane. In this connection, the machining plane is placed through the machining axis and the main contact pressure direction. In particular, if the point of the cone is located in an intersection point of the axis of rotation of the insertion roller shaft and the machining plane, particularly low bearing forces are produced, which act on the adjustment mechanism, particularly also on the shaft accommodation.

In order to be able to adjust the insertion roller shaft at different angles relative to the work piece, it is advantageous if the axis of rotation of the insertion roller shaft and the axis of rotation of the shaft accommodation enclose an angle with one another. In this way, the result is achieved that the axis of rotation of the insertion roller shaft describes just this cone when the shaft accommodation rotates about its axis of rotation, and the insertion rollers can be adjusted in different positions relative to a work piece, i.e. to the machining axis of the transport segment. In this connection, it was determined that it is advantageous if the axis of rotation of the shaft accommodation is disposed at a slant to a perpendicular of the machining axis of the transport segment.

Mounting of the insertion roller shaft on the shaft accommodation, with which the possibilities described above can be achieved, is configured in particularly simple construction if the shaft accommodation has a bore for accommodating an insertion roller shaft and the bore is disposed at a slant relative to the axis of rotation of the shaft accommodation.

In order for the axis of rotation of the insertion roller shaft to describe a cone during rotation of the shaft accommodation, as explained, the shaft accommodation preferably has a bore whose entry and exit openings are at different distances from the axis of rotation of the shaft accommodation.

In order to be able to dispose the cone point as close as possible in the region of the machining axis, it is advantageous if an opening of the bore of the shaft accommodation is disposed closer to the axis of rotation of the shaft accommodation on the face of the shaft accommodation that faces the insertion rollers, than an opening of the bore on the face of the shaft accommodation that faces away from the insertion rollers.

In order to keep the number of components of the adjustment mechanism as low as possible, it is advantageous if the shaft accommodation has a self-locking drive. The shaft accommodation can be controlled particularly precisely by means of the self-locking drive, and furthermore, no additional means, such as braking devices or holding devices, are required for locking the shaft accommodation in place, since the self-locking drive fixes the shaft accommodation in its desired operating position with a particularly simple construction.

In order to further simplify such a self-locking drive in terms of its construction, it is advantageous if the self-locking drive has a self-locking screw gear mechanism or worm wheel gear mechanism and/or a hydraulic regulating motor.

In order to be able to advantageously implement the advantages of the cutting machine described above, particularly the advancing apparatus described above, in practice, a corresponding method for adjusting an insertion roller of an advancing apparatus relative to a machining axis of a transport segment is proposed, for this purpose, in which method an axis of rotation of the insertion shaft is displaced, rotated about the axis of rotation of the bearing bushing, and the axis of rotation of the bearing bushing has at least one component parallel to the axis of rotation of the insertion roller shaft. In this way, a particularly reliable method, which requires particularly little maintenance, for adjusting an insertion roller relative to a work piece that is moved in linear manner, is implemented. Particularly with regard to the parallel components, the necessary adjustment forces can be managed in significantly simpler and better manner.

It is particularly advantageous if the axis of rotation of the insertion roller shaft tumbles about the axis of rotation of the bearing bushing during rotation of the bearing bushing. By means of such a movement, an insertion roller can be individually adjusted to the needs, in each instance, in particularly simple manner.

A preferred method variant provides that during rotation of the bearing bushing, an angle between 0° and 10°, preferably an angle between 0° and 5°, is adjusted between the axis of rotation of the insertion roller shaft and the machining axis of the transport segment. In order to be able to adjust an insertion roller between work pieces having a relatively low diameter and a work piece having a relatively greater diameter, in comparison, sufficiently well, an adjustment possibility of an angle between 0° and 1.25° is preferably used in practice.

Cumulatively or alternatively to the characteristics explained above, a cutting machine for machining linear work pieces, particularly rods, pipes, round bars, wires, cables, or the like, having an advancing device, is proposed, whereby the advancing device has an advancing apparatus that is separably connected with an intake guide, and the advancing apparatus and the intake guide are separably connected with one another by means of at least one quick-action device.

Such advancing devices, which have an intake guide and an advancing apparatus, are preferably used for transporting linear work pieces in systems, such as a peeling machine. In this connection, the insertion device guarantees continuous feed of a work piece for a system, in that it accelerates and continuously transports a work piece. In general, in the case of such advancing devices, the advancing apparatus is provided first, and then, in the transport direction, the intake guide is subsequently provided, before the work piece is guided into the corresponding system. The essential function of the intake guide consists in guiding the work piece that is accelerated and continuously transported by the advancing apparatus into the system, in targeted manner. The advancing apparatus and the intake guide are often combined into a unit in fixed manner, in other words they are not releasable under normal conditions, according to the state of the art, and they can be moved together, for example for the purpose of a tool replacement on the system in question. In order to guarantee precise guidance of the work piece in operation, the advancing device is connected with the system in fixed manner, during operation. However, it is a disadvantage of the known advancing devices that the advancing apparatus and the intake guide form a non-releasable unit and cannot be separated from one another, at least in the installed state. To accomplish work on the advancing apparatus and the intake guide, it is necessary to disassemble the advancing apparatus at least in part, depending on the scope of the work to be performed. This makes maintenance and repair work, in particular, more difficult, if such work is required on a component of the advancing apparatus or of the intake guide.

For example, a peeling machine is known from DE 40 19 286 A1, in which individual modules, such as an insertion unit and a guidance system, are disposed to be displaceable relative to a peeling machine housing. In this connection, the insertion unit is braced to the guidance system by way of a plurality of screws. Furthermore, at the same time, the insertion unit and the guidance system are mounted on the peeling machine housing in such a manner that they can be braced, by means of additional guide rails. These guide rails reach from the peeling machine housing all the way to the insertion unit, and are disposed with regard to the other modules in such a manner that they penetrate these modules parallel to the transport direction of the insertion unit. At their ends, the guide rails have either a counter-nut or a clamping wedge, in each instance, so that when the guide rails are “braced,” not only the insertion unit but also the guidance system and the peeling machine housing are clamped to one another, and thereby connected with one another. It is disadvantageous in this connection, for one thing, that the insertion unit can be separated from the guidance system only in complicated and difficult manner. This makes maintenance and repair work significantly more difficult. For another thing, the guide rails that run through all the modules are disadvantageous, since they possess a relatively great inherent expansion. This holds true even if the guide rails are made of high-quality materials. This has the result that only a limited bracing force can be applied for clamping the modules together. As a result, the modules braced in this manner have only a conditional rigidity. This in turn has a negative effect on the machining, i.e. peeling results, since relatively great machining forces are present in the region of the peeling head during peeling, in order to achieve the required precision during peeling of a work piece. The disadvantages explained above are eliminated by means of the machine described above, particularly a peeling machine, and by means of its advancing device.

A quick-action device, as mentioned above, can be configured in many different ways. In general, the term “quick-action device” is understood to be a device with which a connection between two elements can be produced or released in uncomplicated and quick manner. Preferably, the quick-action device is automated, so that manual work with additional tools is superfluous. This differentiates such connections very significantly from a simple screw connection, with which two elements are connected.

A preferred embodiment variant provides that the quick-action device has at least one wedge clamp element. Wedge clamp elements are advantageously available as standard products, so that the present quick-action device can be advantageously implemented in this manner. Furthermore, wedge clamp elements, in particular, have the advantage that in the unlocked state of the wedge clamp elements, the components that were previously braced together can be separated at a distance from one another, without any connecting parts of a bracing device remaining between the separated components, which might otherwise be disturbing. Advantageously, this also brings about the possibility of producing or releasing a connection between the advancing apparatus and the intake guide in quick and particularly simple manner, in terms of construction.

In this manner, maintenance and repair work on the intake guide can also easily be performed on both sides, for one thing, so that the implementation of such work is significantly facilitated, which is particularly advantageous in the case of sensitive or filigree intake guides. For another thing, no additional construction space has to be provided for such work on the advancing apparatus, particularly on the intake guide side part of the advancing apparatus, since the advancing device preferably merely has to be separated from a system, and furthermore the intake guide merely has to be separated from the advancing apparatus and moved back towards the system, in order to easily reach the intake guide side part of the advancing apparatus, for example. This can be done in particularly simple manner by means of a quick-action device.

For another thing, a cutting machine is proposed for this purpose, cumulatively or alternatively, which has an advancing device, an intake guide, and a peeling machine gear mechanism, whereby not only the advancing apparatus but also the peeling machine gear mechanism can be separably connected with the intake guide, independent of one another.

The term “peeling machine gear mechanism” in this sense is understood to be, in general, a fixed base body of a cutting machine, particularly a peeling machine. This base body is, for example, a rack, a frame, or some other structure, which essentially reaches around into the region around the peeling head.

Because the two modules, the advancing apparatus and the peeling machine gear mechanism, can be connected with one another individually, and, in particular, independent of one another, with the intake guide, in operationally reliable manner, work on individual sections of a peeling machine can be performed significantly more easily and with less effort. Thus it is possible, for example, to perform work in a region between the intake guide and the peeling machine gear mechanism, without any need for also separating the advancing apparatus from the intake guide. Instead, the intake guide, together with the advancing apparatus, can be released from the peeling machine housing and displaced as a rigidly connected module. This also results in advantages with regard to accident protection, since significantly fewer loose, displaceable modules have to be handled in the case of such work. This promotes reducing the risk of an accident.

Probably one of the biggest advantages can be seen in the fact that because of this independent connecting, a significantly more rigid advancing device is available than before. This more rigid advancing device is implemented in that for one thing, the advancing apparatus is disposed directly on the intake guide. As a result, bracing forces are introduced into the modules to be braced by way of very short force flow paths, thereby implementing far more rigid connections than was usual previously.

For another thing, the intake guide is directly and separably connected with the peeling machine gear mechanism, in advantageous manner. As a result, bracing forces are introduced into the modules to be connected in the present case, also by means of a significantly more rigid connection.

As a result, the complete advancing device does not have to be separated from the system, depending on the application case, but instead, it is already sufficient to merely separate the advancing apparatus from the intake guide and to move it in such a manner that the intake guide remains disposed on the system, regardless. For these reasons alone it is advantageous if the advancing apparatus and the intake guide are displaceable relative to one another, particularly even in the installed state.

In order to be able to make a sufficiently large assembly space available between the advancing apparatus and the intake guide, when work is being performed on individual components or modules of the advancing device, a distance of more than 200 mm, preferably more than 500 mm or more than 600 mm, respectively, can be adjusted between the advancing apparatus and the intake guide.

In order to configure a release between the advancing apparatus and the intake guide, relative to one another, with as simple a construction as possible, it is advantageous if the advancing apparatus and the intake guide are releasably fixed to one another by means of a clamping device. In this way, the work steps required for bracing or releasing can be kept as low as possible in terms of their number and with regard to their time expenditure.

One embodiment variant provides that the clamping device has at least one catch means, one bracing element, one tie bolt and/or one index bolt.

The term “catch means” is understood, in this connection, to mean any device with which the advancing apparatus can be fixed, at least preliminarily, to the intake guide, or vice versa, so that in this connection, the advancing apparatus and the intake guide are connected with one another to form an advancing device. Pre-fixing facilitates further bracing work, since the components to be braced have already been fixed in place securely relative to one another, and perhaps also positioned in sufficiently correct alignment.

The term “bracing element” comprises, for example, all components that are suitable for connecting the advancing apparatus and the intake guide with one another in such a manner that they are rigidly but separably connected with one another, particularly during operation.

Such bracing elements can include, among other things, tie bolts, whereby a tie bolt is preferably passed through a rack of the advancing apparatus and/or a rack of the intake guide, and the tie bolt is generally braced with a screw nut at its ends, in each instance, in such a manner that the advancing apparatus and the intake guide are connected with one another to form an advancing device that is reliable in operation.

The index bolts can furthermore, cumulatively or alternatively, serve as centering aids, so that the advancing apparatus and the intake guide, particularly when they are brought together, generally undergo guidance at several locations. In addition, the advancing apparatus and the intake guide are connected with one another so as to prevent rotation, by means of providing such index bolts at a plurality of regions. Accordingly, the term “index bolts” in the sense of the invention includes those components that are suitable for guiding the advancing apparatus and the intake guide when they are brought together, at several locations, particularly perpendicular to the guide path, and furthermore for configuring the two-part advancing device in sufficiently stable manner, by means of two or more index bolts, particularly so as to resist distortion and to be sufficiently stable despite its division into two parts.

In order to move the advancing apparatus and intake guide, when they are released from one another, relative to one another but also relative to a work piece machining system, a preferred embodiment provides that both the advancing apparatus and the intake guide are mounted to be displaceable along a linear guide. The advancing apparatus and the intake guide are mounted particularly securely on such a linear guide, and can be moved relative to one another in very precise and quick manner. It is understood that such a linear guide is advantageous also independent of the other characteristics of the present invention.

In a concrete implementation, it is possible that the intake guide has a case that is resistant to twisting, which preferably communicates with the linear guide by way of runner shoes. It is understood that such a case is particularly resistant to twisting if it is closed. By means of such a case, a particularly compact unit is created, which furthermore can be connected with the advancing apparatus, but also with a work piece machining system, particularly well. The runner shoes of the twist-resistant case then allow precise guidance on the linear guide. Furthermore, it is advantageous that the twist-resistant case is connected with a sub-base in very stable manner, by means of the runner shoes and a linear guide that is attached to the sub-base.

Accordingly, it is also advantageous if the advancing apparatus has a twist-resistant frame that preferably communicates with a linear guide by way of runner shoes. Here, the advantages already explained with regard to the twist-resistant case of the intake guide are also obtained. Such twist-resistant frame for the advancing apparatus and the intake guide, respectively, are advantageous even independent of the other characteristics of the present invention.

In order to be able to displace the advancing apparatus and/or the intake guide without expenditure of great manual effort, it is advantageous if the advancing apparatus and/or the intake guide have means for displacement. Such a means for displacement is, for example, a hydraulic cylinder that moves the advancing apparatus along a linear guide. Likewise, the intake guide can be moved with such a hydraulic cylinder. But the advancing apparatus and/or the intake guide can easily be moved towards one another or towards a peeling machine by means of a hand-activated crank and a correspondingly advantageous gear transmission ratio.

Furthermore, a system, such as a peeling machine, for machining linear work pieces, particularly rods, pipes, round bars, wires, cables, or the like, is proposed, whereby the system has an advancing device as described above. In particular, the advantages of the present advancing device have a particularly advantageous effect in connection with a peeling machine. However, for the sake of completeness, it should already be mentioned at this point that the characteristics with regard to machining corresponding work pieces with such an advancing device are advantageous even without the other characteristics of the invention.

By means of using the present advancing device on a machine, known work piece machining systems, such as peeling machines, are significantly improved, since the time for a shut-down of a work piece machining system, for example when performing maintenance or repair work, can be significantly shortened as such.

It is particularly advantageous if the entire advancing device or parts of it is/are separably connected with the remainder of the work piece machining system. In this way, maintenance and repair work can be carried out significantly more simply and quickly, since the advancing device, in the installed state, can be separated into a “first part” consisting of the advancing apparatus and into “another part” consisting of the intake guide, and the two “parts” can be moved individually or together.

It has been shown that it is furthermore advantageous if the work piece machining system has a linear guide on which an advancing device and/or an intake guide are disposed in displaceable manner, independent of one another. In this way, the advancing apparatus and the intake guide can be moved individually relative to one another as well as individually relative to the remainder of the work piece machining system, in relatively quick manner and with operational reliability.

A particularly preferred embodiment variant provides that the linear guide is configured in such a manner that a distance of more than 200 mm, preferably more than 500 mm, can be adjusted between the advancing apparatus or the intake guide and the remainder of the work piece machining system, in each instance. By means of such distances relative to one another, a sufficiently large assembly space is guaranteed, so that work can be performed on the advancing apparatus or on the adjustment guide, as well as on the adjustment guide side part of the remainder of the work piece machining system, without requiring too much construction space for the arrangement as a whole.

This can be guaranteed, in particular, if the linear guide is configured to be integrated into a sub-base.

Furthermore, it is advantageous if the advancing device or parts of it are releasably fixed to the remainder of the work piece machining system by means of a bracing device. In this way, the entire advancing device can be fixed in place, advantageously in releasable manner, on the remainder of the work piece machining system. The arrangement is particularly simple and inexpensive to build if the bracing device between the advancing apparatus and the intake guide and the bracing device between the advancing device and the remainder of the work piece machining system are identical.

In this connection, it is also advantageous if the bracing device has at least one catch element, one bracing element, one tie bolt and/or one index bolt.

At this point, it should be noted that the characteristics with regard to the advancing device are advantageous even without the other characteristics of the present invention.

Cumulatively or alternatively, a method for performing work on an advancing device of a system is furthermore proposed, in which an advancing apparatus and an intake guide are displaced separated from one another and relative to one another, in such a manner that for one thing, an assembly space is formed between the intake guide and the advancing apparatus, and for another, such space is formed between the latter two and the remainder of the system.

It has been shown that the characteristics of such a method for performing work on an advancing device of a system is advantageous even independent of the other characteristics of the invention as described.

Such a method has a particularly facilitating effect on maintenance and repair work of an advancing device, so that in the case of such work, a system, such as a peeling machine, can be used again significantly more quickly. Until now, parts of an advancing device could not be displaced relative to one another relatively quickly, and instead, the conventional advancing devices had to be disassembled, in complicated manner.

Such a method of the individual components can take place in particularly simple and quick manner if the advancing device and/or the intake guide of the advancing device are displaced along a guide, preferably along a linear guide.

Additional advantages, aims, and properties of the present invention are described using the following explanation of the attached drawing, in which two tool heads and peeling machines with other modules are shown as examples.

Additional advantages, aims, and properties of the present invention are described using the following explanation of the attached drawing, in which two tool heads and peeling machines with other modules are shown as examples.

The drawing shows:

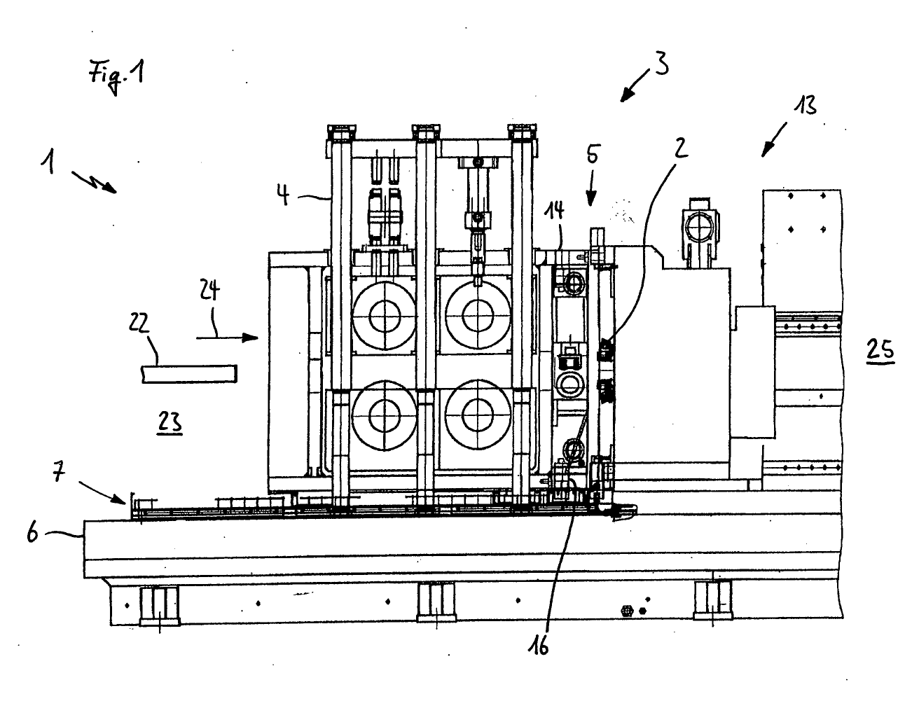

FIG. 1 a peeling machine in the region of a tool head, particularly a peeling head, and an advancing device with an advancing apparatus and an intake guide,

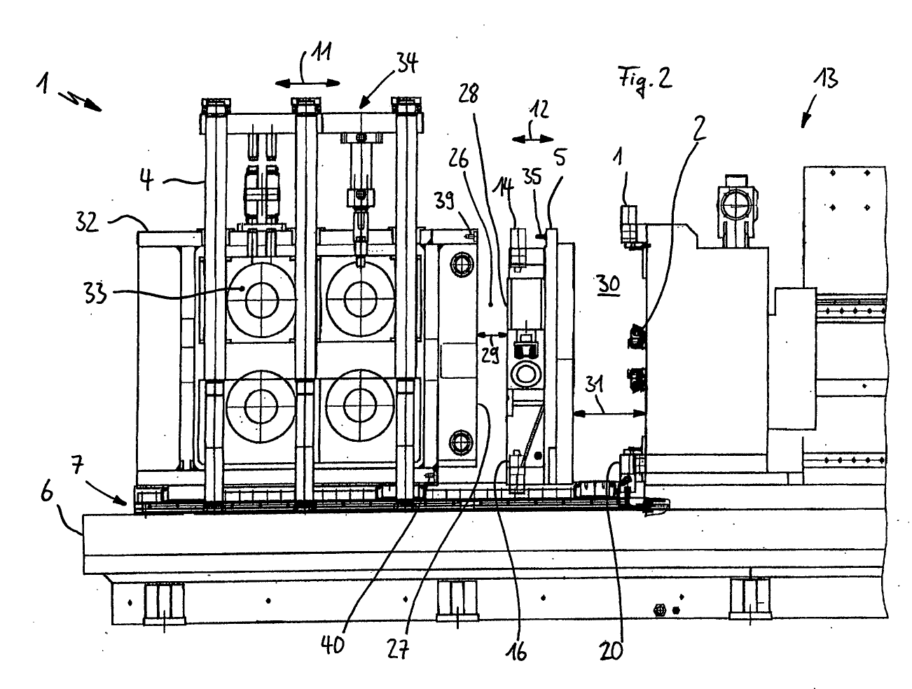

FIG. 2 the peeling machine from the previous FIG. 1, in which the advancing apparatus is separated from the intake guide, and also the intake guide is separated from the peeling machine gear mechanism,

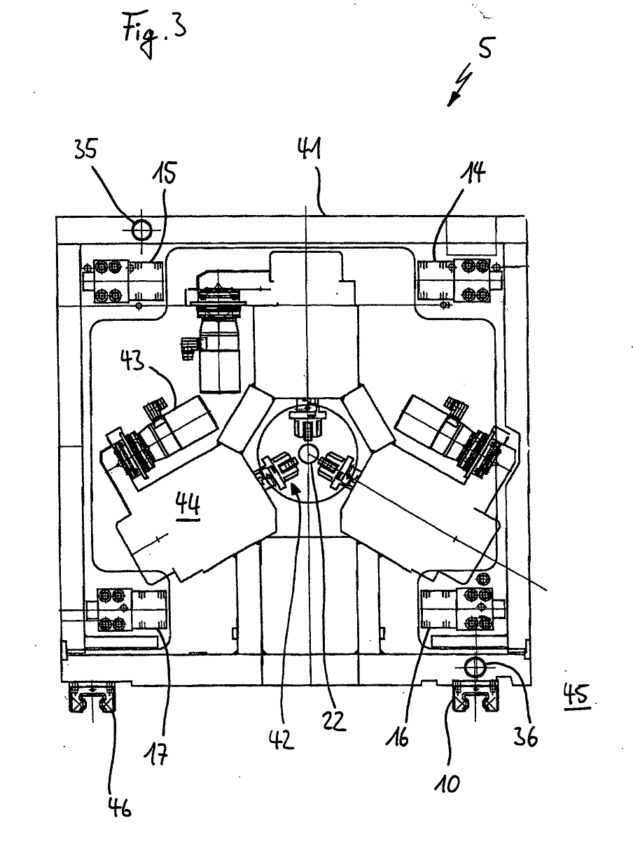

FIG. 3 schematically, a view of the intake guide with wedge clamp elements in the transport direction of a work piece to be peeled,

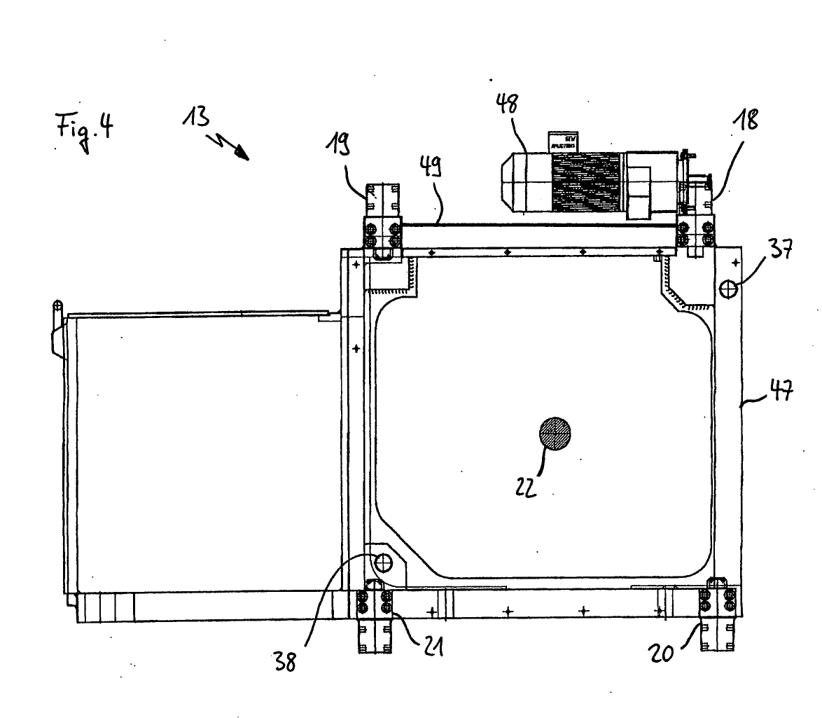

FIG. 4 schematically, a view of the peeling machine gear mechanism, with wedge clamp elements in the transport direction of the work piece to be peeled,

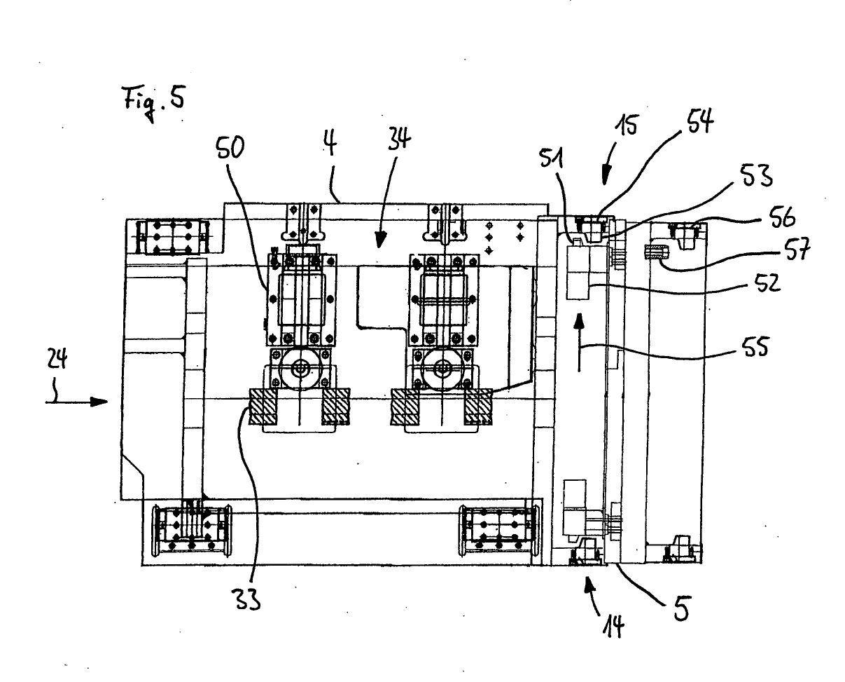

FIG. 5 schematically, a top view of the intake guide, braced with the advancing apparatus,

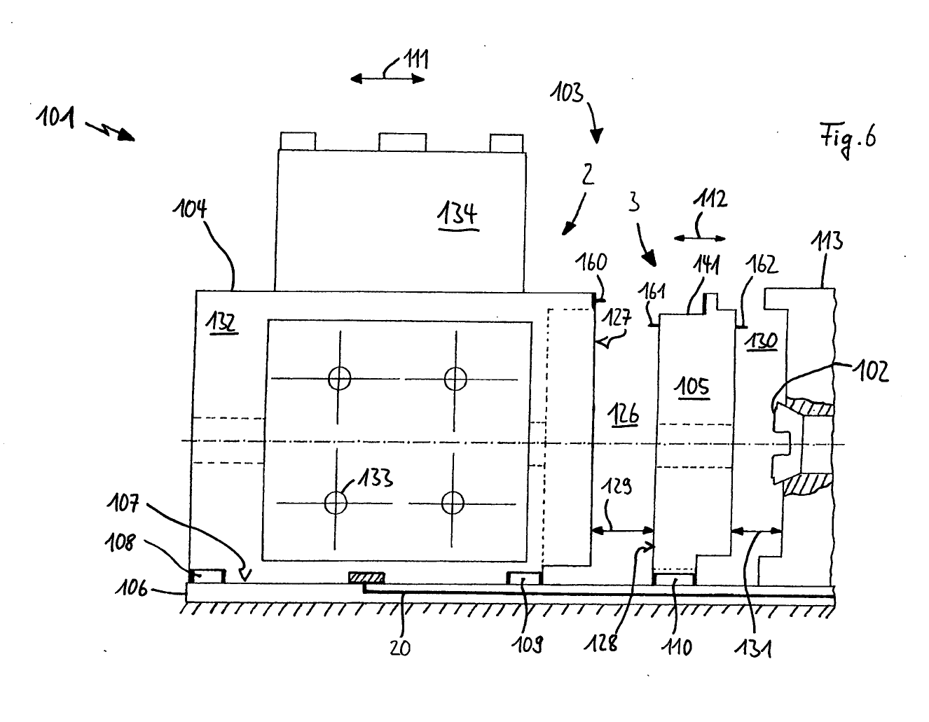

FIG. 6 schematically, another peeling machine, having an intake guide separated from a peeling machine gear mechanism, and an advancing apparatus separated from the intake guide, whereby both the intake guide and the advancing apparatus is mounted on a linear guide,

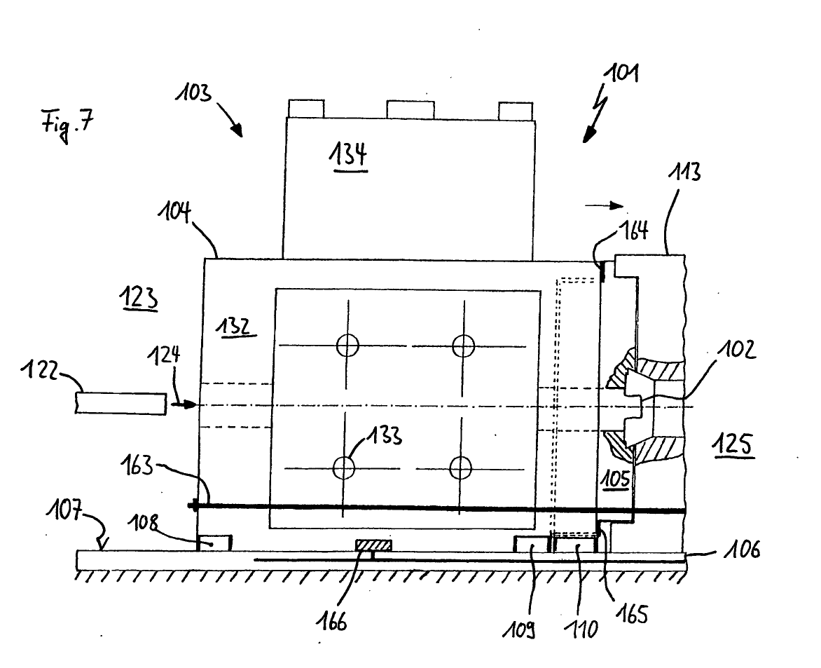

FIG. 7 schematically, an advancing device having an advancing apparatus of the peeling machine from FIG. 6, previously separated from the intake guide,

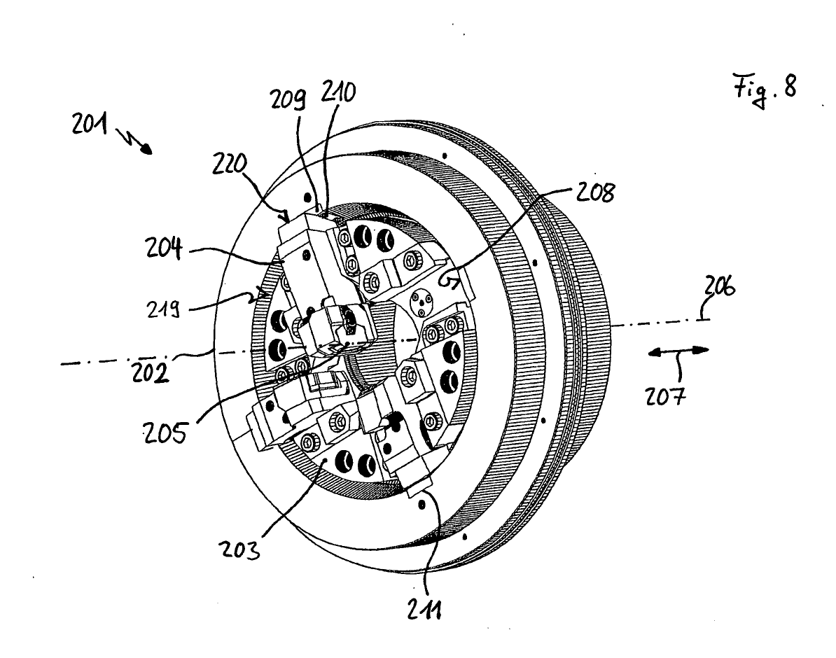

FIG. 8 a perspective view of a first tool head of one of the peeling machines mentioned above,

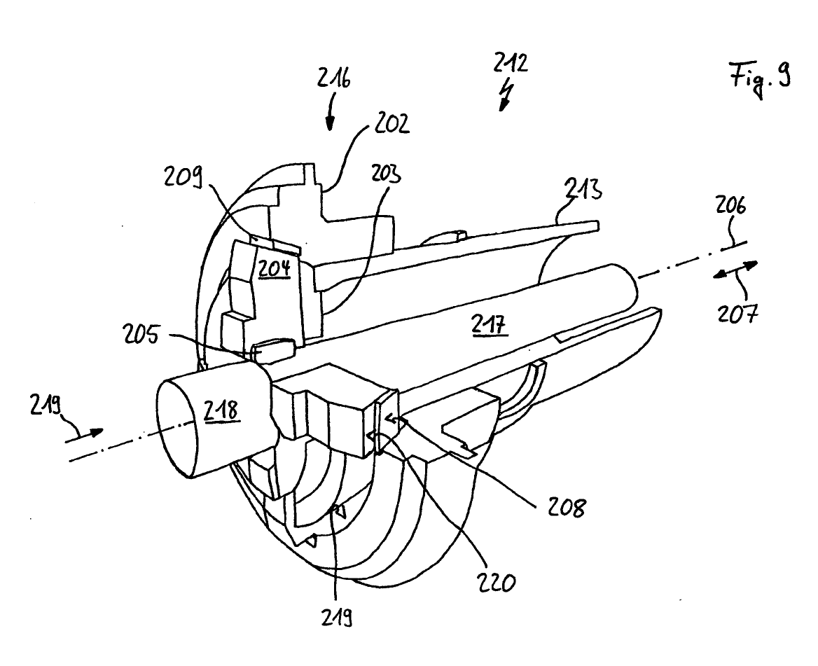

FIG. 9 a partially cut view of another tool head, which rotates about a work piece to be peeled,

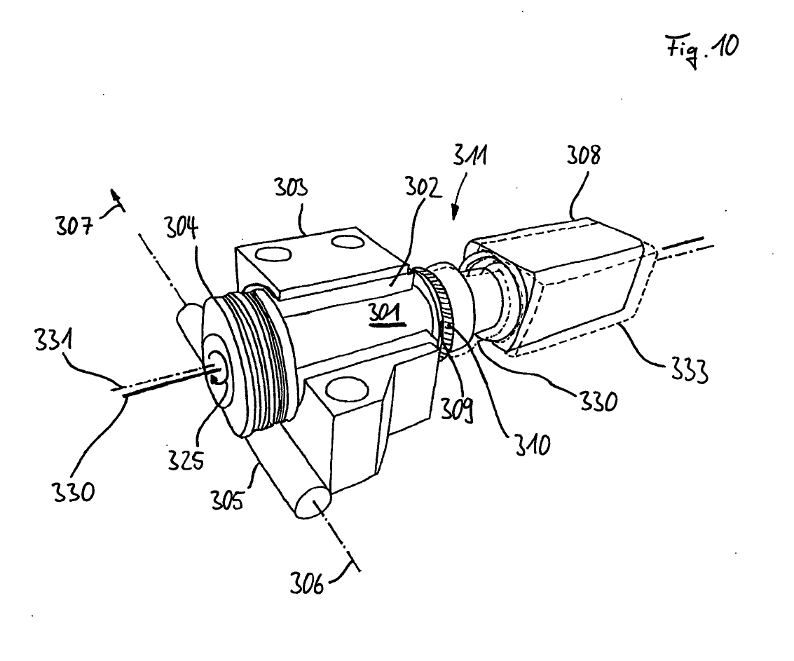

FIG. 10 an arrangement according to the invention of a bearing bushing and an insertion roller shaft disposed in it, including an insertion roller shaft motor,

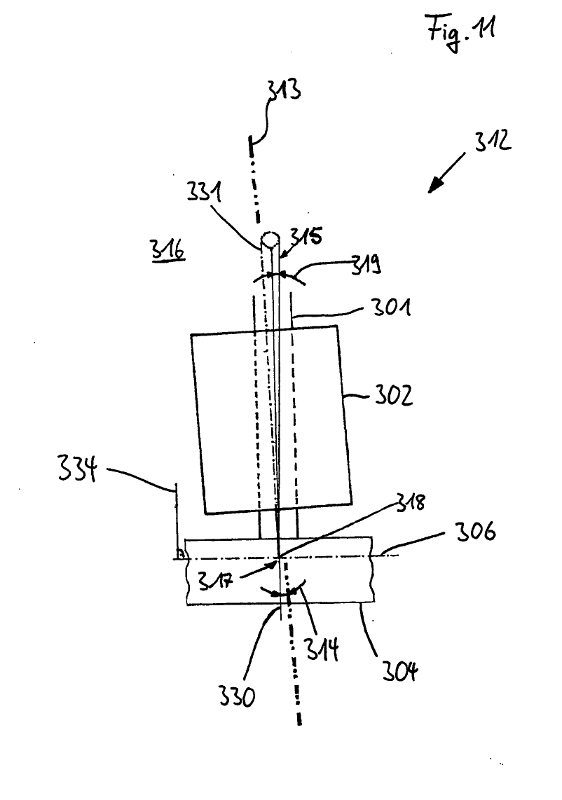

FIG. 11 schematically, a representation of an angle adjustment of an insertion roller shaft with a corresponding bearing bushing, relative to a machining axis of a transport segment, and

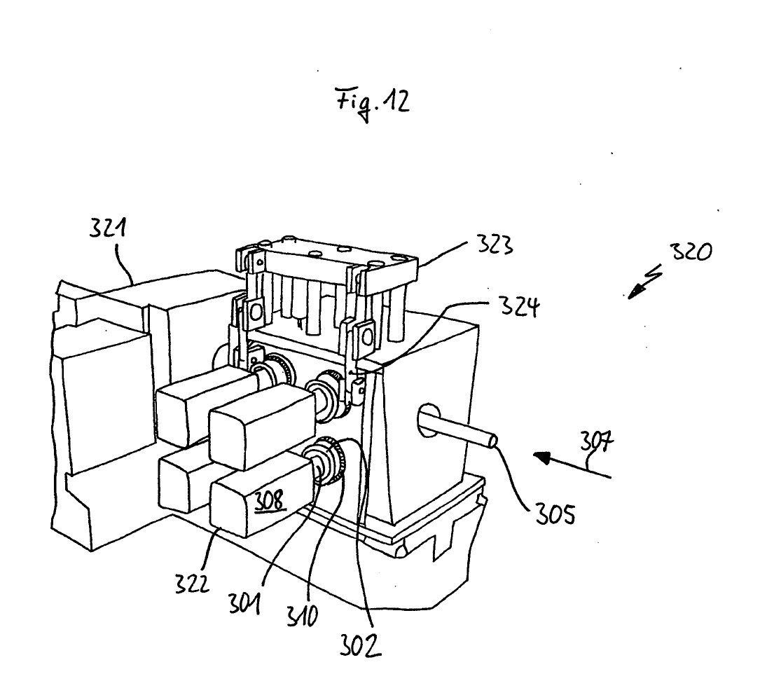

FIG. 12 schematically, a perspective view of an advancing apparatus with four insertion roller shafts.

Both the peeling machines 1 shown in FIGS. 1 and 2 and the peeling machine 101 shown in FIGS. 6 and 7 have an advancing device 3 and 103, respectively, in the region of their peeling head 2 and 102, respectively.

The advancing device 3 shown in FIGS. 1 and 2 has an advancing apparatus 4 and an intake guide S. The advancing apparatus 4 and the intake guide 5 are disposed displaceably on a traverse 6 of the peeling machine 1, whereby the traverse 6 forms a linear guide 7 for the advancing apparatus 4 and the intake guide 5. Both the advancing apparatus 4 and the intake guide 5 can be moved along the linear guide 7 by means of runner shoes 108, 109, and 110 (see FIGS. 6 and 7 in this regard) or similar arrangements, in both directions of the arrows 11 and 12. Therefore the advancing apparatus 4 and the intake guide 5 can be individually moved away from a peeling machine gear mechanism 13 of the peeling machine 1 or moved towards the peeling machine gear mechanism 13 of the peeling machine 1, for one thing. For another, the advancing apparatus 4 and the intake guide 5 can also be moved relative to one another. This means that the advancing apparatus 4 can be moved on the traverse 6 even independent of the intake guide 5, and vice versa. In the operating state of the peeling machine 1 illustrated in FIG. 1, the advancing apparatus 4 and the intake guide 5 are connected with one another to form a compact advancing device 3, and the advancing device 3 is furthermore connected with the peeling machine gear mechanism 13 of the peeling machine 1 with the intake guide 5. So that both the advancing apparatus 4 and the intake guide 5, particularly in the operating state shown here, are reliably connected with the peeling machine gear mechanism 13, the advancing apparatus 4 and the intake guide 5 are rigidly but releasably clamped to one anther by means of first upper wedge clamp elements 14 and 15 (see also FIG. 3), for one thing, and also by means of first lower wedge clamp elements 16 and 17 (see also FIG. 3). For another thing, the intake guide 5 and the peeling machine gear mechanism 13 are clamped together rigidly but releasably, by means of first lower wedge clamp elements 18 and 19 (see FIG. 4) as well as by means of second lower wedge clamp elements 20 and 21 (see also FIG. 4). In this braced state, a work piece can be guided precisely to the peeling head 2 of the peeling machine 1 by means of the advancing apparatus 4 by way of the intake guide 5. For this purpose, the work piece 22 is continuously guided through the peeling machine 1, in the direction of the arrow 24, from an inlet region 23 to an outlet region 25, by means of the advancing device 3. According to the representation of FIG. 2, the advancing apparatus 4 has been displaced to a distance away from the intake guide 5, in such a manner that an assembly space 26 is formed between the advancing apparatus 4 and the intake guide 5, which permits both good accessibility at the intake guide side end 27 of the advancing apparatus 4 and at the advancing apparatus side end 28 of the intake guide 5. In order to implement the assembly space 26, the advancing apparatus 4 is spaced apart from the intake guide 5 at the distance 29.

Furthermore, in the arrangement according to FIG. 2, the advancing apparatus 4 and the intake guide 5 have been displaced from the peeling machine gear mechanism 13 of the peeling machine 1 to such a distance that another assembly space 30 is made available between the intake guide 5 and the peeling machine gear mechanism 13. The intake guide 5 is accordingly removed from the peeling machine gear mechanism 13 by a distance 31. The advancing apparatus 4 has a twist-resistant frame 32, in which not only the intake rollers 33 (numbered here only as an example) but also the drive and adjustment mechanism 34 of the intake rollers 33 are disposed. Furthermore, the intake guide 5 has a first locking pin 35 and a second locking pin 36 (see FIG. 3 in this regard) in this exemplary embodiment. The peeling machine gear mechanism 13 also has a first locking pin 37 and a second locking pin 38 (see FIG. 4). The first locking pin 35 of the intake guide 5 works together with a complementary locking sleeve 39 in the operating state (see FIG. 1) of the peeling machine 1, and the second locking pin 36 works together with a complementary locking sleeve 40, in the operating state, accordingly. The locking pins 35 and 36 ensure that the frame 32 of the advancing apparatus 4 and a twist-resistant case 41 (see FIG. 3) of the intake guide 5 are moved towards one another in guided manner. Furthermore, the twist-resistant frame 32 and the twist-resistant case 41 are mounted in twist-resistant manner, relative to one another, by means of the locking pins 35 and 36, in addition to the linear guide 6.

By means of the locking pins 35 and 36, the entire advancing device 3 holds together in significantly more robust and twist-resistant manner. The same also holds true with regard to the locking pins 37 and 38 of the peeling machine gear mechanism 13. These act together with corresponding locking sleeves (not explicitly shown here), which are provided on the intake guide 5. The active connection will be explained in detail in the present case, merely as an example, between the advancing apparatus 4 and the intake guide 5. Depending on the concrete configuration, sufficient guidance and fixation of the modules described above, relative to one another, can already be achieved merely with two locking pins and corresponding complementary locking sleeves. It is understood that in other exemplary embodiments, however, more than two locking pins and locking sleeves can be used. In this exemplary embodiment, the intake guide 5 additionally has locking pins 14 and 15, which pre-fix the advancing apparatus 2 and the intake guide 3 independent of the bracing device 13. In the twist-resistant case 41 of the intake guide 5, in this exemplary embodiment, three guide rollers 42 (numbered here only as an example), disposed in star shape relative to one another, are provided. Each of these guide rollers can advantageously be controlled individually by means of a regulating motor 43 (numbered here only as an example), by way of a corresponding regulating motor gear mechanism 44, so that the work piece 22 to be peeled is guided to the peeling head 2 (see FIG. 2) with extremely great precision. In the lower region 45 of the twist-resistant case 41 of the intake guide 5, a first runner shoe 10 and a second runner shoe 46 are disposed. The intake guide 5 is connected with the linear guide 7 of the peeling machine 1 by way of the two runner shoes 10 and 46, in such a manner as to be translationally displaceable.

The peeling machine gear mechanism 13 (see FIG. 4) has a rigid housing 47, on which the two upper wedge clamp elements 18 and 19 and the two lower wedge clamp elements 20 and 21 are disposed. The wedge clamp elements 18, 19, 20, and 21 can be controlled by means of a drive motor 48, by way of a hydraulic device 49 (here only shown between the wedge clamp elements 18 and 19). Furthermore, the two locking pins 37 and 28 of the peeling machine gear mechanism 13 are disposed on the rigid housing 47. The structure and the method of action of the wedge clamp elements 14 to 21 present on the entire peeling machine 1 is shown using the first upper wedge clamp elements 14 and 15 (see FIG. 5). The first upper wedge clamp elements 14, 15 clamp the advancing apparatus 4 to the intake guide 5, together with the first lower wedge clamp elements 16 and 17 (see FIG. 3). The advancing apparatus 4 is shown, in the representation according to FIG. 5, with its two upper intake rollers 33 (only numbered as examples, see FIG. 2), and a part 50 of the drive and adjustment mechanism mechanism 34 (see also FIG. 2). The work piece 22 to be peeled is guided to the peeling head 2 (see FIG. 1) in the transport direction 24, by means of the intake rollers 33 of the advancing apparatus 4.

In order to connect the advancing apparatus 4 in operationally reliable manner with the intake guide 5, as shown in FIG. 5, a locking wedge 51, which is translationally movable, of a first bracing component 52 engages behind a rigidly fixed stop wedge 53 of a second bracing component 54. Both the first bracing component 52 and the second bracing component 54 are components of the wedge clamp component 15, whereby the first bracing component 52 is a block cylinder of the wedge clamp element 15 and the second bracing component 54 is a solid stop. The first bracing component 52, in this exemplary embodiment, is disposed on the intake guide 5, and the second bracing component 54 is accordingly disposed on the advancing apparatus 4. If the advancing apparatus 4 and the intake guide 5 have been moved towards one another, as shown in FIG. 5, that the two are adjacent to one another, the locking wedge 51 is moved out of the block cylinder of the first bracing component 52, in the direction of the arrow 55, by means of suitable hydraulics 49 (see FIG. 4). In this connection, the locking wedge 51 works together with the stop wedge 53 of the second bracing component 54, more and more intimately, until finally, the advancing apparatus 4 is connected with the intake guide 5 in rigid and operationally reliable manner. In order to release the connection between the advancing apparatus 4 and the intake guide 5 again, the locking wedge 51 is moved opposite the direction of the arrow 55, so that the active connection between the locking wedge 51 and the stop wedge 53 slowly gives way, and the two bracing components 52 and 54 are finally completely separated from one another. It is understood that the other wedge clamp elements 14, 16 to 21 of the peeling machine 1 have an identical structure, as explained for the wedge clamp element 15 as an example. Accordingly, their methods of effect also correspond to that of the wedge clamp element 15 explained above. In order for the intake guide 5 to be connected with the peeling machine gear mechanism 13 in the same manner, the intake guide 5 has not only a first bracing component 52 of a wedge clamp element, but furthermore also a second bracing component 56 of a wedge clamp element 19. The wedge clamp element 19 is shown here to stand for all four wedge clamp elements 18, 19, 20, and 21, which are provided for an operationally reliable connection between the intake guide 5 and the peeling machine gear mechanism 13. In order to guarantee additional stability between the intake guide 5 and the peeling machine gear mechanism 13, the intake guide 5 has an additional locking pin 57, which reaches into the rigid housing 47 of the peeling machine gear mechanism 13, once the intake guide 5 and the peeling machine gear mechanism 13 have been connected with one another.

The peeling machine 101 shown in FIG. 6 has an advancing device 103 having an advancing apparatus 104 and an intake guide 105. The advancing apparatus 103 and the intake guide 105 are disposed displaceably on a traverse 106 of the peeling machine 101, whereby the traverse 106 forms a linear guide 107 for the advancing apparatus 104 and the intake guide 105. Both the advancing apparatus 104 and the intake guide 105 can be moved along the linear guide 107 by means of runner shoes 108, 109, and 110, in the direction of the arrows 111 and 112. Therefore the advancing apparatus 104 and the intake guide 105 can be individually moved away from the peeling machine gear mechanism 113 or moved towards the peeling machine gear mechanism 113, for one thing. For another, the advancing apparatus 104 and the intake guide 105 can also be moved relative to one another. This means that the advancing apparatus 104 can be moved on the traverse 106 even independent of the intake guide 105, and vice versa. In the arrangement according to FIG. 6, the advancing apparatus 104 has been displaced at such a distance from the intake guide 105 that an assembly space 126 is formed between the advancing apparatus 104 and the intake guide 105, which permits both good accessibility at the intake guide side end 127 of the advancing apparatus 104 and at the advancing apparatus side end 128 of the intake guide 105. In order to implement the assembly space 126, the advancing apparatus 104 is spaced apart from the intake guide 105 at the distance 129.

Furthermore, in the arrangement according to FIG. 6, the advancing apparatus 104 and the intake guide 105 have been displaced from the peeling machine gear mechanism 113 to such a distance that another assembly space 130 is made available between the intake guide 105 and the peeling machine gear mechanism 113. The intake guide 105 is accordingly removed from the peeling machine gear mechanism 113 by a distance 131. The advancing apparatus 104 has a twist-resistant frame 132, in which not only the intake rollers 133 (numbered here only as an example) but also the drive and adjustment mechanism 134 of the intake rollers 133 are disposed. Furthermore, both the advancing apparatus 104 and the intake guide 105 have index bolts 160, 161, and 162, which work together with complementary sleeves in the advancing apparatus 104 and the peeling machine gear mechanism 113, respectively, and are not shown and numbered specifically here. The index bolts 160 and 161 ensure that the frame 132 of the advancing apparatus 104 and a twist-resistant case 141 of the intake guide 105 are moved towards one another in guided manner, at least on the approach segment. Furthermore, the twist-resistant frame 132 and the twist-resistant case 141 are mounted in twist-resistant manner, relative to one another, by means of the index bolts 160 and 161, in addition to the linear guide 107. By means of the additional index bolts 160 and 161, the entire advancing device 103 holds together even more robustly. The additional index bolt 162 has a similar effect between the intake guide 104 and the peeling machine gear mechanism 113. Depending on the concrete configuration, sufficient guidance and fixation of the modules described above, relative to one another, can already be achieved merely with one or two index bolts 160, 161, or 162 and corresponding complementary sleeves. It is understood that if necessary, any desired number of index bolts 160, 161, and 162 can be provided, however.

In the operating state (see FIG. 7), the advancing apparatus 104 and the intake guide 105 are connected with one another to form an advancing device 103, and the advancing device 103 is furthermore disposed on the peeling machine gear mechanism 113. So that both the advancing apparatus 104 and the intake guide 105, particularly in the operating state, are reliably connected with the peeling machine gear mechanism 113, the advancing apparatus 104, the intake guide 105, and the peeling machine gear mechanism 113 are braced together to form a compact unit, by means of an additional bracing device 163. In this exemplary embodiment, the advancing apparatus 104 and the intake guide 105 additionally have catch means 164 and 165, which pre-fix the advancing apparatus 104 and the intake guide 105 together with one another, independent of the bracing device 163. In the braced state, a work piece 22 can be precisely guided to a peeling head 102 of the peeling machine 101 by means of the advancing apparatus 104 by way of the intake guide 105. For this purpose, the work piece 122 is continuously guided through the peeling machine 101, in the direction of the arrow 124, from an inlet region 123 to an outlet region 125, by means of the advancing device 103. In order to displace the advancing apparatus 104 and the intake guide 105 relative to one another, for one thing, and relative to the peeling machine gear mechanism 113, for another, the advancing apparatus 104 and the intake guide 105 have a hydraulic regulating mechanism (numbered only as an example here), in each instance.

The tool head 201 shown in FIG. 8 consists essentially of an adjuster ring 202, or a tool holder accommodation 203, as well as four tool holders 204 (numbered only as examples here) that are disposed on the tool holder accommodation 203. The tool holders 204 each have a tool 205 (numbered only as an example here), with which a work piece 217 (see FIG. 9) is to be freed of a scale layer 218 (see also FIG. 9), or machined in some other way. The tool head 201 rotates about a machining axis 206 as the work piece 217 is being machined. The tool holders 204 are adjusted radially relative to the machining axis 206 by means of the adjuster ring 202, in such a manner that the tools 205 can be appropriately adjusted relative to the work piece 217. The tool holders 204 are guided in the tool holder accommodation 203, in each instance, in such a manner that they hold and guide the tools 205 in radially displaceable manner relative to the work piece 217, i.e. the machining axis 206. The individual adjustment of the tool holders 204 takes place, in this connection, by means of a displacement of the adjuster ring 202 in the axial direction 207, whereby the displacement of the adjuster ring 202 accordingly runs axially to the machining axis 206. The inside 219 of the adjuster ring 202 is configured to be conical, as such. The tool holders 204 communicate with planar slide surfaces 208 of the adjuster ring 202, which are provided in the cone-shaped region, by way of slide surfaces 220. The tool accommodation 203 remains fixed in place on the hollow shaft 213, as a rule, during the axial displacement of the adjuster ring 202 relative to the hollow shaft 213 (see FIG. 9), so that the adjuster ring 202 moves relative to the tool accommodation 203. Both the slide surfaces 220 of the tool holders 204 and the slide surfaces 208 of the adjuster ring 202 that communicate with them are configured to be planar, so that the slide surfaces 220 and 208 that communicate with one another enter into interaction over as large an area as possible. In order to implement the planar slide surfaces 208 on the inside 219 of the adjuster ring 202 with as simple a construction as possible, the slide surfaces 208 are implemented by means of inlays 209 in this exemplary embodiment. In this connection, the inlays 209 are small hard metal plates that are disposed on the inside 219 of the adjuster ring 202, by means of four Imbus screws 210 (numbered only as examples here) on a groove 211 provided for this purpose. By means of the inlays 209, two different ideas are implemented. First of all, the inlays 209 are disposed on the inside 219 of the adjuster ring 202 in such a manner that they essentially run the same way, relative to the machining axis 206, as the rest of the conical inside 219. Second of all, the inlays 209 have no curved surface on their slide surfaces 208, as the remainder of the inside 219 does, but instead, are configured to be planar, i.e. without curvature. Therefore the tool holders 204 can easily be displaced along the machining axis 206 as the adjuster ring 202 is being displaced, and furthermore are in interaction with the adjuster ring 202, i.e. the inside 219 of the adjuster ring 202, by way of planar slide surfaces 220 and 208, so that in the region of these planar slide surfaces 220 and 208, particularly forces that act radially are transferred better from the tool holders 204 to the adjuster ring 202. Therefore the regions around or on the slide surfaces 220 and 208 are subject to significantly less wear than in the case of conventional tool heads 201. It should be pointed out once more at this point that such planar slide surfaces 208 can be implemented not just by means of inlays 209, as shown in this exemplary embodiment. It is understood that such planar slide surfaces 208 can also be machined directly on the inside 219 of the adjuster ring 202. However, the use of the proposed inlays 209 is particularly economical, since these inlays 209 can easily be removed when they have reached a critical level of wear, by loosening the Imbus screws 210, and replaced with new inlays 209. The slide surfaces 220 on the tool holders 204 are advantageous, in any case, since they can be machined onto the tool holders 204 significantly more easily than the known slide surfaces 220 having a conical shape. But here again, inlays 209 can advantageously be used, so that an inlay 209 disposed on the adjuster ring 202 communicates with an inlay 209 disposed on a tool holder 204, for example.

The tool head 212 shown in FIG. 9 essentially has a similar structure as the tool head 201 already known from FIG. 8, so that components having the same effect in both exemplary embodiments are provided essentially with the same reference number. The tool head 212 has an adjuster ring 202 that can slide on a hollow shaft 213, in the axial direction 207, along the machining axis 206. Furthermore, the hollow shaft 213 has a tool holder accommodation 203 at its end 216 facing towards the adjuster ring 202, which guides the individual tool holders 204. The tool holders 204 have tools 205, on their side facing the machining axis 206, with which the work piece 217 can be freed of its scale layer 218, in cutting manner, or machined in some other manner. As a result, the work piece 217 moves in the advancing direction 219 along the machining axis 206. Inlays 209 are disposed between the tool holder 204 and the adjuster ring 202, and the inlays 209 have planar surfaces 208, so that the tool holders 204, which also have planar slide surfaces 220 in the region of the planar slide surfaces 208 or the inlays 209. Therefore the tool holders 204 can communicate with planar slide surfaces 208 of the adjuster ring 202, by way of planar slide surfaces 220, although the inside 219 of the adjuster ring 202 is configured to be conical, for the remainder.

FIG. 10 shows an insertion roller shaft 301, which is mounted to rotate in a bearing bushing 302. The bearing bushing 302 in turn is mounted to rotate about an axis of rotation 313 (see FIG. 11), in a holding device 303. Therefore not only the insertion roller shaft 301, but also the bearing bushing 302 can be rotated relative to the holding device 303. Furthermore, it is possible to rotate the bearing bushing 302 both relative to the holding device 303 and relative to the insertion roller shaft 301. Rotation of the insertion roller shaft 301 is even possible if the bearing bushing 302 does not rotate relative to the holding device 303. The insertion roller shaft 301 rotates about an axis of rotation 330 in a first orientation. At one end of the insertion roller shaft 301, an insertion roller 304 is disposed, which transports a work piece 305 along a machining axis 306, in the direction of the arrow 307, during rotation in a clockwise direction 325. A drive motor 308 is disposed on the end of the insertion roller shaft 301 opposite the insertion roller 304, which motor drives the insertion roller shaft 301. The bearing bushing 302 has a rotating ring 309, which is provided with a slanted gear mechanism 310. In this connection, the angle of incline of the slanted gear mechanism 310 is selected to be so great that the slanted gear mechanism 310 represents a self-locking gear mechanism that holds the bearing bushing 302 in a certain position, once it has been set, until this position is actively changed again. The insertion roller shaft 301 is disposed on a slant in the bearing bushing 302, so that the first axis of rotation 330 of the insertion roller shaft 301 shifts when the bearing bushing 302 is displaced into a further position, and the insertion roller shaft 301 has another axis of rotation 331, which deviates from the first axis of rotation 330 of the insertion roller shaft 301. Therefore the insertion roller 304 is set to a different angle relative to the work piece 305, i.e. relative to the machining axis 306. The two different positions of the axes of rotation 330 and 331, which are shown only as examples here, represent only a selection from among many positions that go beyond them, which the insertion roller shaft 301 can assume by means of rotation of the bearing bushing 302 about the axis of rotation 313. In order to better illustrate the possibilities of displacement of the insertion roller shaft 301 schematically, the insertion roller shaft 301 is indicated with a dot-dash line in a displaced position 332, in the region of its side 311 facing away from its insertion roller 304, so that it is more easily evident from FIG. 10 how the insertion shaft 301 can move relative to its first position. Furthermore, the drive motor 308 is also shown in a displaced position 333, also with a dot-dash line.

The view 312 shown schematically in FIG. 11 shows a bearing bushing 302, in which an insertion roller shaft 301 is mounted at a slant. In this connection, the bearing bushing 302 rotates about an axis of rotation 313, whereas the insertion roller shaft 301 rotates about an axis of rotation 330. The axis of rotation 313 of the bearing bushing 302 is adjusted at an angle 314 relative to the axis of rotation 330 of the insertion roller shaft 301. If the bearing bushing 302 now rotates about its axis of rotation 313, the axis of rotation 330 of the insertion roller shaft 301 disposed at a slant in the bearing bushing 302 rotates in such a manner that the axis of rotation 330 virtually writes a cone 315 in the space 316, and the cone 315 has a point 317 that lies in an intersection 318 of the insertion roller shaft plane, in which the insertion roller shaft axis 330 lies, and which is oriented perpendicular to the plane of the figure and therefore parallel to the main contact pressure direction of the insertion roller 304 onto the work piece 305, and in which the machining plane 306 has its origin. The insertion roller shaft plane extends at a slant relative to the perpendicular 334 disposed relative to the machining plane 306. In this way the insertion roller 304 can be adjusted at different angles relative to the machining axis 306 and, accordingly, also relative to a work piece 305, in a structurally simple manner. By means of this arrangement, it is possible to displace the axis of rotation 330 of the insertion roller shaft 301 between 0° and 1.25°, and thereby to achieve a sufficient adjustment of the insertion roller 304 relative to the work piece 305. Therefore the insertion roller 304 can be adapted to the changing demands of different diameters of the work pieces 305. The arrangement allows an extremely fine and precise adjustment of the corresponding angles, among other things.

The advancing apparatus 320 shown in FIG. 12 is part of a peeling machine 321 (only indicated in the background here) and has four adjustment mechanisms 322 (only numbered as examples), whereby the adjustment mechanisms 322 each have a bearing bushing 302 (see FIGS. 10 and 11) with an insertion roller shaft 301 (see FIGS. 10 and 11) disposed at a slant in the former. Aside from the adjustment mechanisms 322, bracing devices can also be provided, in addition, by means of which the insertion rollers can be displaced, i.e. adjusted parallel to their main contact pressure direction on the work piece, in order to be able to suitably adapt their distance to the work piece diameter, in each instance. The four insertion rollers 304 disposed on the advancing apparatus 320 (see FIGS. 10 and 11) transport the work piece 305, in the transport direction 307, to the peeling machine 321, with which a scale layer (not shown here) is removed from the work piece 305, for example, in this exemplary embodiment, whereby the work piece 306 then has a metallically shiny surface (not shown here) subsequent to the peeling process. In the upper region of the advancing apparatus 320, there is a drive and adjustment unit 323, which acts on the slanted gear mechanism 310 of the rotating ring 309 (see FIG. 10), by means of a regulating mechanism 324, in each instance, so that the bearing bushing 302 can be adjusted to a desired position in this connection.

1. Tool head having tool holders that are adjustable essentially radially to an axis of rotation, and an adjusting device that is adjustable essentially axially to the axis of rotation, in which device the tool holders and the adjusting device correspond with one another by way of slide surfaces, in each instance wherein the slide surfaces are essentially planar or have a constant radius of curvature parallel to the axis of rotation.

2. Tool head according to claim 1, wherein at least one slide surface (220, 208) has an inlay (209), which is preferably produced from a wear-resistant material.

3. Tool head according to claim 2, wherein the inlay (209) is a small hard metal plate.

4. Tool head according to claim 1, wherein an inlay (209) is replaceably fixed in place on the adjusting device and/or on the tool holders (204).

5. Tool head according to claim 1, wherein the adjusting device has a conical bushing.

6. Tool head according to claim 5, wherein the conical bushing is an adjuster ring (202).

7. Tool head according to claim 1, wherein a planar slide surface (208) of the adjusting device is disposed essentially parallel to a corresponding slide surface (220) of a tool holder (204), preferably a planar slide surface (220) of a tool holder (204).

8. Adjuster ring for adjusting a tool holder relative to an axis of rotation, whereby the adjuster ring has a conically configured inside for forming a slide bearing half shell, wherein the conical slide bearing half shell has an at least essentially planar slide bearing region.

9. Adjuster ring according to claim 8, wherein the planar slide bearing region is attached to the adjuster ring (202) in releasable and replaceable manner.

10. Adjuster ring according to claim 8, wherein the planar slide bearing region has an inlay (209) having harder material properties than the adjuster ring (202).

11. Cutting machine, particularly a peeling machine, for machining long work pieces (217), wherein a tool head (201; 212) and/or an adjuster ring (202) according to claim 1.

12. Machine according to claim 11, having an advancing apparatus (320) having insertion rollers (304) for accelerating linear work pieces (306), particularly rods, pipes, round bars, wires, cables, and the like, along a machining axis (306) of a transport segment, in which the insertion rollers (304) are driven by means of an insertion roller shaft (301), in each instance, wherein at least one insertion roller shaft (301) is mounted eccentrically in a shaft accommodation (302).

13. Machine according to claim 12, wherein the shaft accommodation (302) is mounted to rotate about a shaft accommodation axis (313).

14. Machine according to claim 12, wherein the shaft accommodation (302) is a bearing bushing, and the bearing bushing is disposed to rotate about one of its longitudinal axes, preferably about its middle longitudinal axis, in a holding device (303).

15. Machine according to claim 12, wherein a bearing body having a bearing for the insertion roller shaft (301) is guided on a holding device, that the bearing of the insertion roller shaft performs a movement about a component axis, having a rotation component, which lies in a plane that is disposed parallel to the work piece (306) and is penetrated by the main contact pressure direction, in which the insertion roller, in each instance, acts on the work piece.

16. Machine according to claim 12, wherein the axis of rotation (330) of the insertion roller shaft (301) is disposed relative to the axis of rotation (313) of the shaft accommodation (302), in such a manner that during a rotation of the shaft accommodation (302), the axis of rotation (330) of the insertion roller shaft (301) describes a cone (315) in the space (316).

17. Machine according to claim 16, wherein the cone (315) has a point (317) that is essentially located in an intersection (318) of the axis of rotation (330) of the insertion roller shaft (301) and a perpendicular (334) of the machining plane, preferably essentially in an intersection (318) of the axis of rotation (330) of the insertion roller shaft (301) and the machining plane.

18. Machine according to claim 12, wherein one the axis of rotation (330) of the insertion roller shaft (301) and the axis of rotation (313) of the shaft accommodation (302) enclose an angle (314) with one another.

19. Machine according to claim 12, wherein the axis of rotation (313) of the shaft accommodation (302) is disposed at a slant to the perpendicular (334) of the machining axis (306) of the transport segment.

20. Machine according to claim 12, wherein the shaft accommodation (302) has a bore for accommodating an insertion roller shaft (301) and the bore is disposed at a slant to the axis of rotation (313) of the shaft accommodation (302).

21. Machine according to claim 12, the shaft accommodation (302) has a bore whose entry and exit openings are at different distances from the axis of rotation (313) of the shaft accommodation (302).

22. Machine according to claim 20, wherein an opening of the bore of the shaft accommodation (302) is disposed closer to the axis of rotation (313) of the shaft accommodation (302) on the face of the shaft accommodation (302) that faces the insertion rollers (304), than an opening of the bore on the face of the shaft accommodation (302) that faces away from the insertion rollers (304). claim

23. Machine according to claim 12, wherein the shaft accommodation (302) has a self-locking drive.

24. Machine according to claim 23, wherein the self-locking drive has a self-locking screw gear mechanism or worm wheel gear mechanism and/or a hydraulic regulating motor.

25. Machine according to claim 12 for machining linear work pieces (22), particularly rods, pipes, round bars, wires, cables, or the like, having an advancing device (3; 103), which has an advancing apparatus (4; 104) that is separably connected with an intake guide (5; 105), wherein the advancing apparatus (4; 104) and the intake guide (5; 105) are separably connected with one another by means of at least one quick-action device.

26. Machine according to claim 25, wherein the quick-action device has at least one wedge clamp element (14).

27. Machine according to claim 12, wherein the machine has an advancing device (4; 104), an intake guide (5; 105), and a peeling machine gear mechanism (13; 113), wherein not only the advancing apparatus (4; 104) but also the peeling machine gear mechanism (13; 113) can be separably connected with the intake guide (5; 105), independent of one another.

28. Machine according to claim 12, wherein the intake guide (5; 105) is directly and separably connected with a peeling machine gear mechanism (13; 113).

29. Machine according to claim 12, wherein the advancing apparatus (4; 104) and the intake guide (5; 105) can be displaced relative to one another, even in the installed state.

30. Machine according to claim 12, wherein a distance 29; 129) of more than 200 mm, preferably more than 500 mm, can be adjusted between the advancing apparatus (4; 104) and the intake guide (5; 105).

31. Machine according to claim 12, wherein the advancing device (4; 104) and the intake guide (5; 105) are fixed to one another releasably, by means of a bracing device (163).

32. Machine according to claim 31, wherein the bracing device (163) has at least one catch means (164, 165), one bracing element, one tie bolt and/or one index bolt (160, 161, 162).

33. Machine according to claim 25, wherein both the advancing apparatus (4; 104) and the intake guide (5; 105) are mounted displaceably along a linear guide (7; 107).

34. Machine according to claim 25, wherein the intake guide (5; 105) has a twist-resistant case (41; 141), which preferably communicates with a linear guide (7; 107) by way of runner shoes (10, 46; 108, 109, 110).

35. Machine according to claim 25, wherein the advancing apparatus (4; 104) has a twist-resistant frame (32; 132), which preferably communicates with a linear guide (7; 107) by way of runner shoes (10, 46; 108, 109, 110).

36. Machine according to claim 25, wherein the advancing device (4; 104) and/or the intake guide (5; 105) have means for displacement.

37. Machine for machining linear work pieces, particularly rods, pipes, round bars, wires, cables, or the like, comprising an advancing device according to claim 25.

38. Machine according to claim 37, wherein the entire advancing device (3; 103) or parts (4, 5; 104, 105) of it is/are separably connected with the remainder of the machine.

39. Machine according to claim 37, comprising a linear guide (7; 107) on which an advancing apparatus (4; 104) and an intake guide (5; 105) are displaceably mounted, independent of one another.

40. Machine according to claim 39, wherein the linear guide (7; 107) is configured in such a manner that a distance (30; 130) of more than 200 mm, in each instance, preferably more than 500 mm, can be adjusted between the advancing apparatus (4; 104) or the intake guide (5; 105) and the work piece machining system.

41. Machine according to claim 37, wherein the advancing device (3; 103) or parts (4, 5; 104, 105) of it are releasably fixed on the work piece machining system by means of a bracing device (163).

42. Machine according to claim 41, wherein the bracing device (163) has at least one catch means (164, 165), one bracing element, one tie bolt and/or one index bolt (160, 161, 162).
